(19) United States
(12) Patent Application Publication
(10) Pub. No.: US 2011/0134023 A1
(43) Pub. Date: Jun. 9, 2011

(54) LIQUID CRYSTAL DISPLAY AND DIMMING METHOD AND DIMMING DEVICE FOR BACKLIGHT MODULE

(76) Inventor: Yu-Hsiung Feng, Guangdong (CN)

(21) Appl. No.: 12/862,800

(22) Filed: Aug. 25, 2010

Related U.S. Application Data
(63) Continuation of application No. PCT/CN2009/075973, filed on Dec. 24, 2009.

(30) Foreign Application Priority Data
Dec. 3, 2009 (CN) 200910253582.3

(51) Int. Cl. G09G 3/36

(52) U.S. Cl. 345/102

(57) ABSTRACT

The present invention provides a liquid crystal display including a display panel, a detector, a backlight module and a dimming circuit. The display panel displays a frame. The detector includes a resistor, a first terminal of the resistor is electrically connected to a power system and a second terminal of the resistor is electrically connected to the display panel. The detector detects a real-time current of the display panel through the resistor for estimating an average gray scale value of the frame. The dimming circuit is electrically connected to the backlight module and the detector for adjusting a brightness of the backlight module according to the real-time current of the display panel so that the brightness is in direct or inverse proportion to the average gray scale value of the frame. Thereby, a power consumption of the backlight module is economized.

### Cross Reference To Related Applications

This application is a continuation of PCT/CN2009/075973, filed on Dec. 24, 2009. The contents of PCT/CN2009/075973 are all hereby incorporated by reference.

### BACKGROUND OF THE INVENTION

1. Field of the Invention

The present invention relates generally to a dimming method for a backlight module, and more particularly, to a dimming method for a backlight module of a liquid crystal display (LCD).

2. Description of the Prior Art

LCDs have been widely used in desktop computers and in various portable information products such as cellular phones, notebooks, personal digital assistants (PDAs), digital cameras, digital video cameras, and the like due to its advantages of portability, low power consumption, free of radiation, and low electromagnetic interference. With the rise of the environmental protection consciousness, the power saving issue for the LCD is getting more and more attention.

In the prior art, the backlight module is always turned on, therefore the power consumption of the backlight module is high. In order to overcome this problem, dimming methods for the backlight module have been developed to supply light with adjustable brightness to the LCD according to the gray scale value(s) of the displayed frame. When the gray scale value of the displayed frame is brighter, the brightness of the backlight module is increased; and when the gray scale value of the displayed frame is darker, the brightness of the backlight module is lowered. Accordingly, the power consumption of the backlight module is reduced.

It is noteworthy that if the brightness of the backlight module is adjusted according to the gray scale value of only one single pixel, a bright image can easily be misjudged to be a dark image or a dark image can easily be misjudged to be the bright image. However, if the brightness of the backlight module is adjusted according to an average of the gray scale values of all the pixels, the calculations of the adjustment are substantially increased. Consequently, the power consumption is not reduced while the hardware cost is undesirably further increased.

Please refer to FIG. 1, which is a schematic drawing of a conventional LCD. A timing controller 101 is employed to receive signals from a system power VCC and gray scale values of each of the pixels of the frame displayed by the display panel 104. A computing circuit of the timing controller 101 is used to obtain an average gray scale value of the displayed frame by calculating the gray scale values of the pixels. A pulse-width modulation (PWN) signal PWN1 is transformed to a PWN2 by the timing controller 101 according to the average gray scale value and a converter 102 is used to adjust the brightness of the backlight module 103 according to the system power VCC′ and PWN2. The abovementioned construction complicates the circuits of the timing controller 101, thus the size of the computing circuit is increased. Consequently, the cost is increased.

### SUMMARY OF THE INVENTION

The present invention provides an LCD that is able to adjust a brightness according to a real-time current of a display panel.

The present invention provides a dimming device for a backlight module that is able to economize power consumption of the backlight module.

The present invention provides a dimming method for a backlight module that is able to economize power consumption of the backlight module.

The present invention provides an LCD including a display panel, a detector, a backlight module and a dimming circuit. The display panel is used to display a frame. The detector is electrically connected to the display panel for detecting a real-time current of the display panel and estimating an average gray scale value of the frame. The dimming device is electrically connected to the backlight module and the detector for adjusting a brightness of the backlight module according to the real-time current of the display panel so that the brightness is in direct or inverse proportion to the estimated average gray scale value of the frame.

In one embodiment of the present invention, the brightness is in direct proportion to the average gray scale value of the frame when the display panel operates in the normally white mode, and the brightness is in inverse proportion to the average gray scale value of the frame when the display panel operates in the normally black mode.

In one embodiment of the present invention, the display panel includes a pixel array, a source driver and a gate driver. The pixel array includes a plurality of thin film transistors. Each of the thin film transistors has a source electrode and a gate electrode. The source driver is electrically connected to source electrodes of each one of the thin film transistors and the gate driver is electrically connected to gate electrodes of each one of the thin film transistors.

In one embodiment of the present invention, the detector includes a first resistor to a fifth resistor and a voltage gain amplifier. Each of the resistors includes a first terminal and a second terminal. The first terminal of the first resistor is electrically connected to a system power. The second terminal of the first resistor is electrically connected to the display panel. A resistance of the first resistor is lower than 10 Ohm (Ω) and a current passing through the first resistor is in direct proportion to the real-time current. The detector estimates the average gray scale value by a cross-voltage between the first terminal and the second terminal of the first resistor. The first terminal of the second resistor is electrically connected to the first terminal of the first resistor. The second terminal of the second resistor is electrically connected to the first terminal of the third resistor. The second terminal of the third resistor is electrically connected to a first voltage. A positive input terminal of the voltage gain amplifier is electrically connected to the first terminal of the third resistor. The first terminal of the fourth resistor is electrically connected to the second terminal of the first resistor. The second terminal of the fourth resistor is electrically connected to a negative input terminal of the voltage gain amplifier. The first terminal of the fifth resistor is electrically connected to the second terminal of the fourth resistor. The second terminal of the fifth resistor is electrically connected to an output terminal of the voltage gain amplifier.

In one embodiment of the present invention, the dimming circuit includes a pulse-width modulation circuit, a response time regulating circuit and a phase setting circuit. The pulse-width modulation circuit is electrically connected to an output terminal of the detector for receiving a pulse-width modulation (PWN) signal and adjusting a pulse width of the PWN signal. The response time regulating circuit is electrically connected to the pulse-width modulation circuit for adjusting a response time of the PWN signal. The phase setting circuit is electrically connected to the response time regulating circuit for controlling a phase of the PWN signal.

The dimming circuit includes a first transistor to a twelfth transistor. Each of the transistors has a gate electrode, a first terminal and a second terminal. The gate electrode of the first transistor is electrically connected to the output terminal of the detector. The first terminal of the first transistor is electrically connected to the first voltage. The gate electrode of the second transistor receives the PWN signal. The first terminal of the second transistor is electrically connected to the second terminal of the first transistor. The gate electrode of the third transistor receives the PWN signal. The first terminal of the third transistor is electrically connected to the second terminal of the second transistor. The gate electrode of the fourth transistor is electrically connected to the output terminal of the detector. The first terminal of the fourth transistor is electrically connected to the second terminal of the third transistor. The second terminal of the fourth transistor is electrically connected to a second voltage. The gate electrode of the fifth transistor is electrically connected to the second terminal of the fourth transistor. The first terminal of the fifth transistor is electrically connected to the first terminal of the first transistor. The gate electrode of a sixth transistor is electrically connected to the second terminal of the second transistor and the first terminal of the sixth transistor is electrically connected to the second terminal of the fifth transistor. The gate electrode of the seventh transistor is electrically connected to the second terminal of the second transistor. The first terminal of the seventh transistor is electrically connected to the second terminal of the sixth transistor. The gate electrode of the eighth transistor is electrically connected to the first terminal of the first transistor. The first terminal of the eighth transistor is electrically connected to the second terminal of the seventh transistor. The second terminal of the eighth transistor is electrically connected to the second terminal of the fourth transistor. The gate electrode of the ninth transistor is electrically connected to the second terminal of the sixth transistor. The first terminal of the ninth transistor is electrically connected to the first terminal of the first transistor. The gate electrode of the tenth transistor is electrically connected to the second terminal of the sixth transistor. The first terminal of the tenth transistor is electrically connected to the second terminal of the seventh transistor. The second terminal of the tenth transistor is electrically connected to the second terminal of the fourth transistor. The gate electrode of the eleventh transistor is electrically connected to the second terminal of the ninth transistor. The first terminal of the eleventh transistor is electrically connected to the first terminal of the first transistor. The gate electrode of the twelfth transistor is electrically connected to the second terminal of the ninth transistor. The first terminal of the twelfth transistor is electrically connected to the second terminal of the eleventh transistor. The second terminal of the twelfth transistor is electrically connected to the second terminal of the fourth transistor.

In one embodiment of the present invention, the backlight module is an edge-light type backlight module.

In one aspect of the present invention, the present invention provides a dimming device for backlight module. The dimming device includes a detector and a dimming circuit. The detector is electrically connected to a display panel for detecting a real-time current of a frame displayed by the display panel and estimating an average gray scale value of the frame. The dimming circuit is electrically connected to a backlight module and the detector for adjusting a brightness of the backlight module according to the real-time current of the display panel so that the brightness is in direct or inverse proportion to the estimated average gray scale value.

In another aspect of the present invention, the present invention provides a dimming method for backlight module. The dimming method includes detecting a real-time current of a frame displayed by a display panel and estimating an average gray scale value of the frame, and adjusting a brightness of a backlight module according to the real-time current of the frame so that the brightness is in direct or inverse proportion to the estimated average gray scale value.

In one embodiment of the present invention, a cross-voltage between a first terminal and a second terminal of a resistor is detected. The first terminal of the resistor is electrically connected to a system power and a second terminal of the resistor is electrically connected to the display panel. A current passing through the resistor is in direct proportion to the real-time current. Furthermore, the cross-voltage is amplified to generate a voltage by a voltage gain amplifier, and a duty cycle of a dimming signal is adjusted according to the voltage for adjusting the brightness.

Accordingly, the present invention is to adjust the brightness of a backlight module according to the real-time current of the display panel. Thus the power consumption of the backlight module is economized.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic drawing of a conventional LCD.

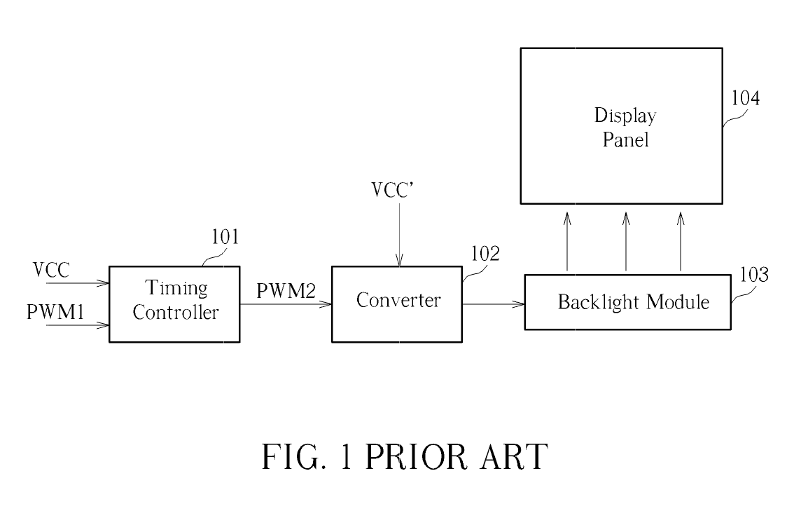

FIG. 2A is a schematic drawing of an LCD provided by an embodiment of the present invention.

FIG. 2B is a schematic drawing illustrating an edge-light type backlight module provided by an embodiment of the present invention.

FIG. 3 is a flowchart of a dimming method for backlight module provided by an embodiment of the present invention.

FIG. 4 is a schematic drawing of a dimming device provided by an embodiment of the present invention.

FIGS. 5A-5C are schematic drawings illustrating an adjustment of a duty cycle of the pulse-width modulation signal provided by an embodiment of the present invention.

### DETAILED DESCRIPTION

The prior art controls the brightness of the backlight module according to the red, green, and blue gray scale values. Thus the amount of numbers needed for calculating the brightness of the displayed subpixels is increased, or can easily cause misjudgment on the bright or dark images.

Different from the prior art, the embodiment of the present invention is to detect a real-time current of a display panel by a resistor that is electrically connected to a system power and the display panel, and to adjust the brightness of a backlight module accordingly. If the display panel operates in the normally white mode, the image gets darker when voltage difference (V_{data}−V_{com}) in the pixel array of the display panel gets larger, and the image gets brighter when the voltage difference in the pixel array of the display panel gets smaller. In other words, the darker the image, the larger the real-time current of the display panel is; and the brighter the image, the smaller the real-time current of the display panel is. It is conceivable that the real-time current of the display panel can be used to indicate the average gray scale value of the frame.

As mentioned above, the resistor is electrically connected to a system power and a display panel, thus the current passing through the resistor indicates the real-time current of the display panel. In other words, the current passing through the resistor is in direct proportion to the real-time current. A cross-voltage between the two terminals of the resistor increases when the current passing through the resistor increases. On the other hand, the cross-voltage reduces when the current passing through the two terminals of the resistor reduces. Accordingly, the present invention detects the cross-voltage between the two terminals of the resistor and estimates the real-time current of the display panel, then adjusts the brightness of the backlight module accordingly. The brightness of the backlight module gets lower when the real-time current of the display panel is larger (dark image) and the brightness of the backlight module gets higher when the real-time current of the display panel is smaller (bright image). Consequently, the power consumption of the backlight module is economized and the hardware cost is also reduced compared with the prior art. Furthermore, the resistor can be a resistor with smaller resistance applied to a voltage gain amplifier, thus the cross-voltage of the resistor with smaller resistance is amplified. Accordingly, the brightness of the backlight module is adjusted to reduce the power.

In the same concept, if the display panel operates in the normally black mode, the image gets brighter when the voltage differences in the pixel array of the display panel gets larger, and the image gets darker when the voltage differences in the pixel array of the display panel gets smaller. In other words, the brighter the image is, the larger the real-time current of the display panel is; and the darker the image is, the smaller the real-time current of the display panel is. The brightness of the backlight module gets higher when the real-time current of the display panel is larger (bright image) and the brightness of the backlight module gets lower when the real-time current of the display panel gets smaller (dark image). Consequently, the power consumption of the backlight module is reduced and the hardware cost is simultaneously reduced compared with the prior art. Please refer to the following descriptions for the drawings illustrating the preferred embodiments. It is noteworthy that the same numerals indicate identical or similar steps.

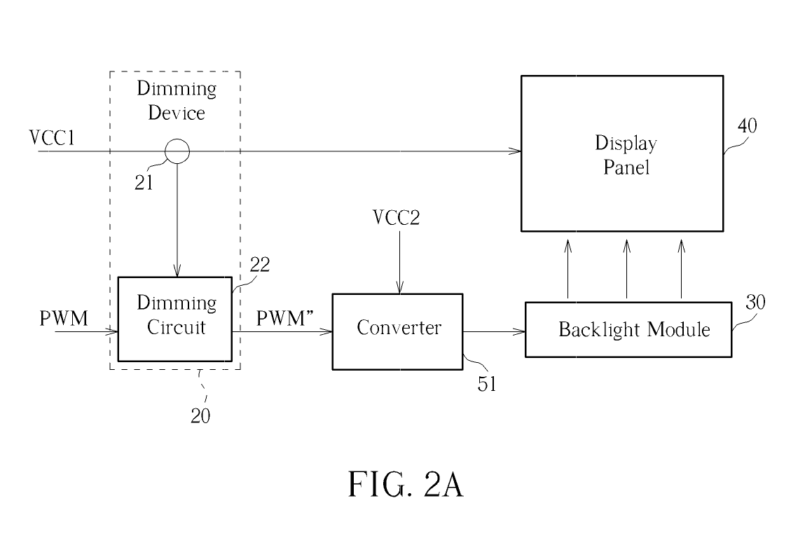

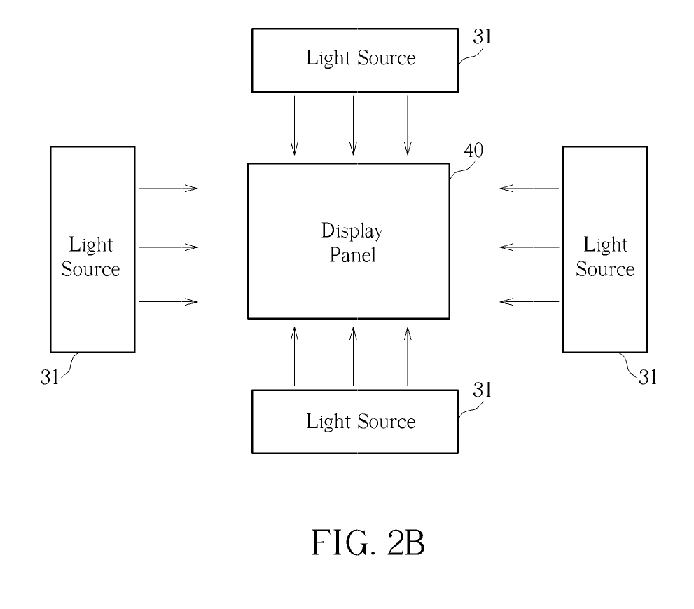

FIG. 2A is a schematic drawing of an LCD provided by an embodiment of the present invention. An LCD 10 includes a dimming device 20, a backlight module 30, a display panel 40 and a converter 51. The dimming device 20 includes a detector 21 and a dimming circuit 22. The display panel 40 includes a pixel array (not shown), a source driver (not shown) and a gate driver (not shown). The pixel array includes a plurality of thin film transistors (not shown). The source driver is electrically connected to source electrodes of each one of the thin film transistors. The gate driver is electrically connected to gate electrodes of each one of the thin film transistors.

A system power VCC1 provides power to the display panel 40. The backlight module 30 is equipped under the display panel 40 for generating a backlight to the display panel 40. The converter 51 is electrically connected to the backlight module 30 for receiving a system power VCC2 and providing the power to the backlight module 30. The detector 21 includes a resistor (not shown) having a first terminal electrically connected to the system power VCC1 and a second terminal electrically connected to the display panel 40. The detector 21 is to detect a real-time current of the display panel 40 by the resistor, indirectly. The dimming circuit 22 is electrically connected to the detector 21 and the converter 51 for controlling the converter 51 according to the real-time current of the display panel 40 detected by the detector 21, and adjusting a brightness of the backlight module 30 accordingly.

In one embodiment, the backlight module 30 is an edge-light type backlight module. FIG. 2B is a schematic drawing illustrating an edge-light type backlight module provided by the embodiment of the present invention. Please refer to FIG. 2B. The backlight module 30 includes a plurality of light sources 31, and the light sources 31 provide an edge-light type backlight to the display panel 40.

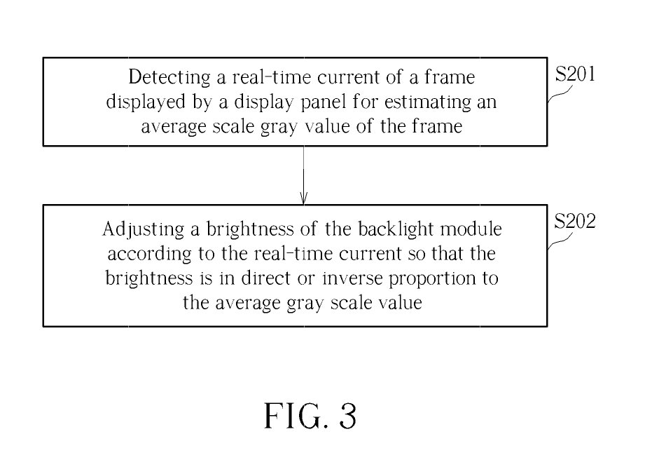

FIG. 3 is a flowchart of a dimming method for backlight module provided by the embodiment of the present invention. Please refer to FIG. 2A and FIG. 3. A step S201 is first performed: the detector 21 detects a real-time current of a frame displayed by the display panel 40 by using a resistor and estimates the average gray scale value of the frame.

Then, a step S202 is performed: the dimming circuit 22 adjusts a brightness of the backlight module 30 according to the real-time current of the display panel 40 so that the brightness of the backlight module 30 is in direct or inverse proportion to the average gray scale value of the frame.

It is noteworthy that in this embodiment, the display panel 40 is exemplarily in normally black display mode. When the display panel 40 displays a bright image, the liquid crystal molecules are rotated substantially, therefore larger voltage difference is needed for the pixel array. And thus power consumption of the display panel 40 when displaying bright image is larger than that when displaying dark image. In addition, a liquid crystal inversion method, such as dot inversion, is often used in the LCD 10, therefore a larger real-time current is required when the display panel 40 displays bright image.

As mentioned above, the dimming circuit 22 adjusts the brightness of the backlight module 30 according to the real-time current of the display panel 40 that is detected by the detector 21. When displaying a bright image, the brightness is increased; and when displaying a dark image, the brightness is reduced. Therefore the power consumption of the backlight module 30 is economized. Furthermore, the provided embodiment does not need to calculate the gray scale values of pixels of the frame, thus calculation is reduced and hardware cost is consequently economized. The use of the dimming device 20 provided by the embodiment is discussed in detail below.

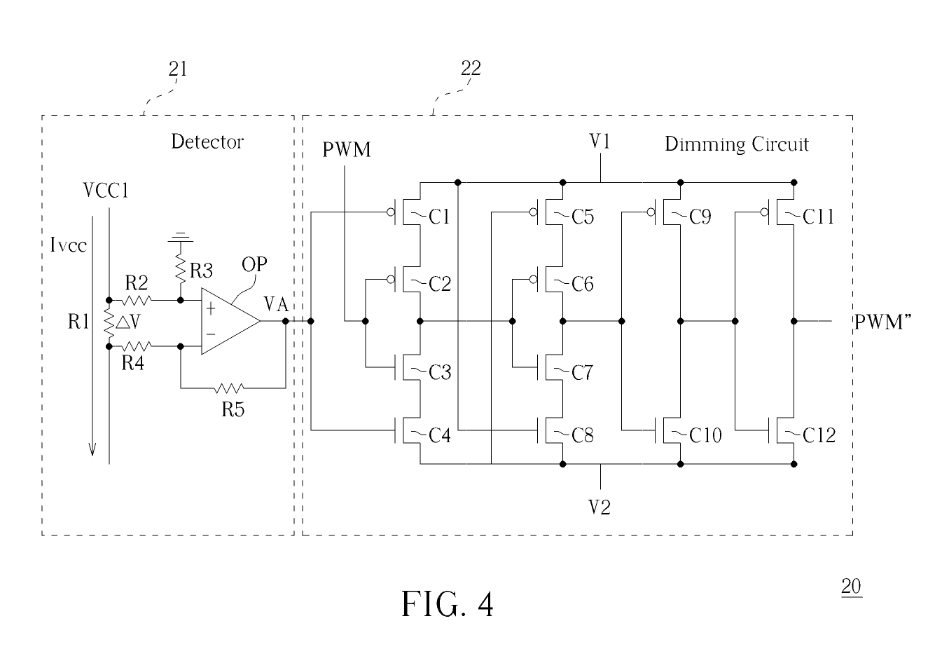

FIG. 4 is a schematic drawing of a dimming device provided by an embodiment of the present invention. The dimming device 20 includes the detector 21 and the dimming circuit 22. The detector 21 is used to transfer a variance of the real-time current Ivcc of the display panel 40 to a variance of voltage ΔV though a resistor R1 having small resistance, and to amplify the variance of the voltage ΔV to a voltage VA that is able to enter the dimming circuit 22 through a voltage gain amplifier OP.

The dimming circuit 22 is used to control a duty cycle of a pulse-width modulation signal PWM by the voltage VA of the detector 21. The detector 21 includes the resistor R1-resistor R5 and the voltage gain amplifier OP. Each of the resistors has a first terminal and a second terminal. The first terminal of the resistor R1 is electrically connected to the system power VCC1. The second terminal of the resistor R1 is electrically connected to the display panel 40. The first terminal of the resistor R2 is electrically connected to the first terminal of the resistor R1. The first terminal of the resistor R3 is electrically connected to the second terminal of the resistor R2. The second terminal of the resistor R3 is electrically connected to a grounding voltage. A positive input terminal of the voltage gain amplifier OP is electrically connected to the first terminal of the resistor R3. The first terminal of the resistor R4 is electrically connected to the second terminal of the resistor R1. The second terminal of the resistor R4 is electrically connected to a negative input terminal of the voltage gain amplifier OP. The first terminal of the resistor R5 is electrically connected to the second terminal of the resistor R4. The second terminal of the resistor R5 is electrically connected to an output terminal of the voltage gain amplifier OP.

In this embodiment, a resistance of the resistor R1 is 1 Ohm, resistances of the resistor R2 and resistor R4 are 10KΩ, and resistances of the resistor R3 and resistor R5 are identical to each other, but not limited to this. Those skilled in the art would easily realize that the resistance of each resistor can be changed according to design requirements. Please note that the lower resistance the resistor R1 has the less power it loses.

It is noteworthy that the current I_{VCC} passing through the resistor R1 is in direct proportion to the real-time current of the display panel. Thus, a cross-voltage between the two terminals of the resistor R1 changes with the changes of the current I_{VCC}. The voltage gain amplifier OP amplifies the cross-voltage ΔV between the two terminals of the resistor R1 to the voltage VA, and controls the dimming circuit 22. Those skilled in the art would easily realize that the resistances of the resistor R3 and the resistor R5 are adjustable according to the requirement for controlling the amplifying ratio of the voltage gain amplifier OP.

The dimming circuit 22 includes three parts: a pulse-width modulation circuit, a response time regulating circuit and a phase setting circuit. The pulse-width modulation circuit includes a transistor C1 and a transistor C4. The response time regulating circuit includes a transistor C5 and a transistor C8. The phase setting circuit includes a transistor C2, a transistor C3, a transistor C6, a transistor C7 and a transistor C9 to a transistor C12. Each of the transistors includes a gate electrode, a first terminal and a second terminal.

The gate electrode of the transistor C1 is electrically connected to an output terminal of the voltage gain amplifier OP. The first terminal of the transistor C1 is electrically connected to a voltage V1, which is exemplarily a positive voltage. The gate electrode of the transistor C2 receives a pulse-width modulation signal PWM. The first terminal of the transistor C2 is electrically connected to the second terminal of the transistor C1. The gate electrode of the transistor C3 receives the pulse-width modulation signal PWM. The first terminal of the transistor C3 is electrically connected to the second terminal of the transistor C2. The gate electrode of the transistor C4 is electrically connected to the output terminal of the voltage gain amplifier OP. The first terminal of the transistor C4 is electrically connected to the second terminal of the transistor C3. The second terminal of the transistor C4 is electrically connected to a voltage V2, which is exemplarily the grounding voltage.

The gate electrode of the transistor C5 is electrically connected to the second terminal of the transistor C4. The first terminal of the transistor C5 is electrically connected to the first terminal of the transistor C1. The gate electrode of the transistor C6 is electrically connected to the second terminal of the transistor C2. The first terminal of the transistor C6 is electrically connected to the second terminal of the transistor C5. The gate electrode of the transistor C7 is electrically connected to the second terminal of the transistor C2. The first terminal of the transistor C7 is electrically connected to the second terminal of the transistor C6. The gate electrode of the transistor C8 is electrically connected to the first terminal of the transistor C1. The first terminal of the transistor C8 is electrically connected to the second terminal of the transistor C7 and the second terminal of the transistor C8 is electrically connected to the second terminal of the transistor C4.

The gate electrode of the transistor C9 is electrically connected to the second terminal of the transistor C6. The first terminal of the transistor C9 is electrically connected to the first terminal of the transistor C1. The gate electrode of the transistor C10 is electrically connected to the second terminal of the transistor C6. The first terminal of the transistor C10 is electrically connected to the second terminal of the transistor C7. The second terminal of the transistor C10 is electrically connected to the second terminal of the transistor C4. The gate electrode of the transistor C11 is electrically connected to the second terminal of the transistor C9. The first terminal of the transistor C11 is electrically connected to the first terminal of the transistor C1. The gate electrode of the transistor C12 is electrically connected to the second terminal of the transistor C9. The first terminal of the transistor C12 is electrically connected to the second terminal of the transistor C11. The second terminal of the transistor C12 is electrically connected to the second terminal of the transistor C4.

The pulse-width modulation circuit is used to adjust a pulse width of the pulse-width modulation signal PWM, which means the pulse-width modulation circuit controls a raising time length and dropping time length of the pulse-width modulation signal PWM. Accordingly the pulse-width modulation circuit controls a duty cycle of the pulse-width modulation signal PWM. The response time regulating circuit is used to control a response time of the pulse-width modulation signal PWM, which means the response time regulating circuit accelerates the raising time or the dropping time of the pulse-width modulation signal PWM. The phase setting circuit is used to control a phase of the pulse-width modulation signal PWM and to generate a pulse-width modulation signal PWN″, which means the phase setting circuit determines the duty cycle being in direct or inverse proportion. The transistors C2-C3, C6-C7, C9-C10 and C11-C12 are the inverters. It is noteworthy that the transistors C2-C3, C6-C7, C9-C10 and C11-C12 also have a buffer function. In the preferred embodiment, each of the transistors C1, C2, C5, C6, C9 and C11 is exemplarily a p-channel transistor. Each of the transistors C3, C4, C7, C7, C10 and C12 is exemplarily an n-channel transistor. The p-channel transistors are turned on by low voltage, therefore the raising time of the pulse-width modulation signal PWN is controlled by the p-channel transistors. When the voltage is low, it shortens the raising time of the pulse-width modulation signal PWN. The n-channel transistors are turned on by high voltage, therefore the dropping time of the pulse-width modulation signal PWN is controlled by the n-channel transistors. When the voltage is high, it lengthens the dropping time of the pulse-width modulation signal PWN. Please refer to the following example.

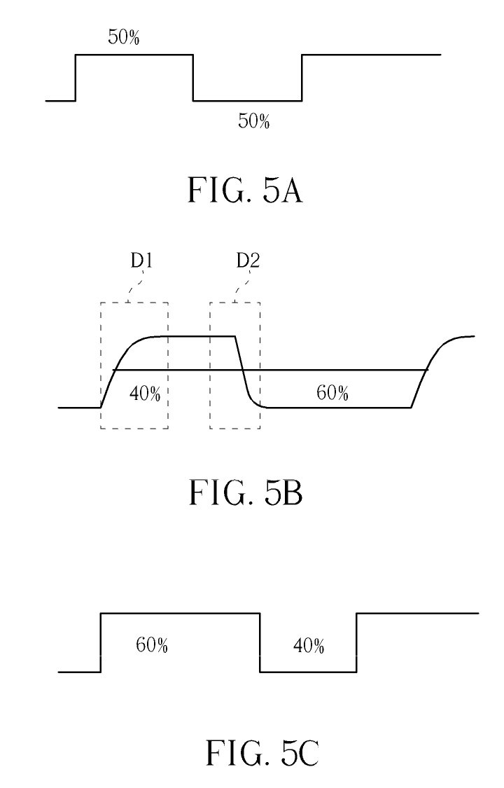

FIGS. 5A-5C are schematic drawings illustrating an adjustment of a duty cycle of the pulse-width modulation signal provided by an embodiment of the present invention. FIG. 5A shows a waveform before adjusting the duty cycle of the pulse-width modulation signal. When the current Ivcc rises, the voltage VA rises, a turn-on time of the n-channel transistor gets short, and the dropping time of the pulse-width modulation signal PWM is consequently short as shown in FIG. 5B. The raising and dropping time length as designated in the dashed frames D1, D2 are determined by the transistor C1 and the transistor C4. The transistor C5 and the transistor C8 are used to transform the waveform in FIG. 5B into standard waveform as shown in FIG. 5C as soon as possible.

The converter 51 determines whether to provide the system power VCC2 to the backlight module 30 or not according to the pulse-width modulation signal PWM″. More specifically, if the duty cycle of the pulse-width modulation signal PWM″ is 40%, the converter 51 is to provide the system power VCC2 to the backlight module 30 for 40% of the cycle, but not to provide the system power VCC2 to the backlight module 30 for 60% of the cycle. Therefore the backlight module 30 provides backlight for 40% of the cycle but does not provide backlight for 60% of the cycle. The switches between the positive period and the negative period of the pulse-width modulation signal PWM″ are so fast that flickers of the backlight module 30 cannot be observed by the human eyes. Human eyes can only observe the differences in brightness of the backlight module 30. Accordingly, by adjusting the duty cycle of the pulse-width modulation signal PWM″, the brightness of the backlight module 30 is changed.

Although the dimming method for backlight module is provided as described in the abovementioned embodiments, those skilled in the art would easily realize that the dimming method is not intended to be limited to the particular embodiments as mentioned above because the dimming method and dimming device for LCD and backlight module are very different. In other words, it should be understood that various changes, substitutions and alterations can be made as long as a dimming method is provided to control the brightness of the backlight module according to the real-time current of the display panel; is and are made without departing from the spirit and scope of the present invention. Please refer to the following embodiment for further illustrating the present invention.

In the abovementioned embodiment the display panel 40 exemplarily operates in the normally black mode, but is not limited to this. The display panel 40 can operate in the normally white mode in other embodiments. For example, when the display panel 40 operates in the normally white mode, larger voltage differences are needed for rotating the liquid crystal molecules when the display panel 40 displays dark image. Therefore power consumption of the display panel 40 when displaying a dark image is larger than that when displaying a bright image. In addition, a liquid crystal inversion method, such as dot inversion, is often used in the LCD 10, therefore larger real-time current is required when the display panel 40 displays a dark image.

As mentioned above, the dimming circuit 22 adjusts the brightness of the backlight module 30 according to the real-time current of the display panel 40 detected by the detector 21. When displaying the bright image, the brightness is increased; when displaying the dark image, the brightness is reduced. Accordingly, the same result is achieved.

The dimming device 20 as shown in FIG. 4 is a preferred embodiment, but those skilled in the art would easily realize that modification to the dimming device 20 as required is not limited. For example, the detector 21 can be a Hall sensor.

In addition, the brightness of the backlight module 30 is adjusted by controlling the duty cycle of the pulse-width modulation signal PWM″, but it is not limited. In other embodiments, the brightness of the backlight module 30 can be adjusted by driving different numbers of light-emitting devices if the backlight module 30 is constructed by a plurality of light-emitting devices.

Accordingly, the present invention adjusts the brightness of the backlight module according to the real-time current of the display panel, thus not only reduces the power consumption but also the hardware costs are economized compared to the prior art.

Those skilled in the art will readily observe that numerous modifications and alterations of the device and method may be made while retaining the teachings of the invention.

What is claimed is:

1. A liquid crystal display (LCD) comprising:
a display panel for displaying a frame;
a detector electrically connected to the display panel for detecting a real-time current of the display panel and estimating an average gray scale value of the frame;
a backlight module; and
a dimming circuit electrically connected to the backlight module and the detector for adjusting a brightness of the backlight module according to the real-time current, so that the brightness is in direct or inverse proportion to the average gray scale value.

2. The LCD of claim 1, wherein the brightness is in direct proportion to the average gray scale value in case the display panel operates in a normally white mode, and the brightness is in inverse proportion to the average gray scale value in case the display panel operates in a normally black mode.

3. The LCD of claim 1, wherein the display panel further comprises:
a pixel array including a plurality of thin film transistors, each of the thin film transistors having a source electrode and a gate electrode;
a source driver electrically connected to the source electrodes; and
a gate driver electrically connected to the gate electrodes.

4. The LCD of claim 1, wherein the detector further comprises:
a first resistor having a first terminal and a second terminal, the first terminal electrically connected to a system power and the second terminal electrically connected to the display panel, wherein a current passing through the first resistor is in direct proportion to the real-time current and the detector estimates the average gray scale value by a cross-voltage between the first terminal and the second terminal of the first resistor.

5. The LCD of claim 4, wherein the detector further comprises:
a second resistor having a first terminal and a second terminal, the first terminal electrically connected to the first terminal of the first resistor;
a third resistor having a first terminal and a second terminal, the first terminal electrically connected to the second terminal of the second resistor and the second terminal electrically connected to a first voltage;
a voltage gain amplifier having an output terminal, a positive input terminal and a negative input terminal, the positive input terminal electrically connected to the first terminal of the third resistor;
a fourth resistor having a first terminal and a second terminal, the first terminal electrically connected to the second terminal of the first resistor and the second terminal electrically connected to the negative input terminal of the voltage gain amplifier; and
a fifth resistor having a first terminal and a second terminal, the first terminal electrically connected to the second terminal of the fourth resistor and the second terminal electrically connected to the output terminal of the voltage gain amplifier.

6. The LCD of claim 4, wherein a resistance of the first resistor is lower than 10 Ohm (Ω).

7. The LCD of claim 1, wherein the dimming circuit further comprises:
a pulse-width modulation circuit electrically connected to an output terminal of the detector, the pulse-width modulation circuit receives a pulse-width modulation (PWN) signal for adjusting a pulse width of the PWN signal;
a response time regulating circuit electrically connected to the pulse-width modulation circuit for adjusting a response time of the PWN signal; and
a phase setting circuit electrically connected the response time regulating circuit for controlling a phase of the PWN signal.

8. The LCD of claim 1, wherein the dimming circuit further comprises:
a first transistor having a first terminal, a second terminal and a gate electrode, the gate electrode electrically connected to the output terminal of the detector and the first terminal electrically connected to a first voltage;
a second transistor having a first terminal, a second terminal and a gate electrode, the gate electrode used to receive the PWN signal, the first terminal electrically connected to the second terminal of the first transistor;
a third transistor having a first terminal, a second terminal and a gate electrode, the gate electrode used to receive the PWN signal and the first terminal electrically connected to the second terminal of the second transistor;
a fourth transistor having a first terminal, a second terminal and a gate electrode, the gate electrode electrically connected to the output terminal of the detector, the first terminal electrically connected to the second terminal of the third transistor, and the second terminal electrically connected to a second voltage;
a fifth transistor having a first terminal, a second terminal and a gate electrode, the gate electrode electrically connected to the second terminal of the fourth transistor and the first terminal electrically connected to the first terminal of the first transistor;
a sixth transistor having a first terminal, a second terminal and a gate electrode, the gate electrode electrically connected to the second terminal of the second transistor and the first terminal electrically connected to the second terminal of the fifth transistor;
a seventh transistor having a first terminal, a second terminal and a gate electrode, the gate electrode electrically connected to the second terminal of the second transistor and the first terminal electrically connected to the second terminal of the sixth transistor;
an eighth transistor having a first terminal, a second terminal and a gate electrode, the gate electrode electrically connected to the first terminal of the first transistor, the first terminal electrically connected to the second terminal of the seventh transistor, and the second terminal electrically connected to the second terminal of the fourth transistor;
a ninth transistor having a first terminal, a second terminal and a gate electrode, the gate electrode electrically connected to the second terminal of the sixth transistor and the first terminal electrically connected to the first terminal of the first transistor;
a tenth transistor having a first terminal, a second terminal and a gate electrode, the gate electrode electrically connected to the second terminal of the sixth transistor, the first terminal electrically connected to the second terminal of the seventh transistor, and the second terminal electrically connected to the second terminal of the fourth transistor;
an eleventh transistor having a first terminal, a second terminal and a gate electrode, the gate electrode electrically connected to the second terminal of the ninth transistor and the first terminal electrically connected to the first terminal of the first transistor; and
a twelfth transistor having a first terminal, a second terminal and a gate electrode, the gate electrode electrically connected to the second terminal of the ninth transistor, the first terminal electrically connected to the second terminal of the eleventh transistor, and the second terminal electrically connected to the second terminal of the fourth transistor.

9. The LCD of claim 1, wherein the backlight module is an edge-light type backlight module.

10. A dimming device for backlight module comprising:
a detector electrically connected to a display panel for detecting a real-time current of a frame displayed by the display panel and estimating an average gray scale value of the frame; and
a dimming circuit electrically connected to the backlight module and the detector for adjusting a brightness of the backlight module according to the real-time current so that the brightness is in direct or inverse proportion to the average gray scale value.

11. The dimming device of claim 10, wherein the brightness is in direct proportion to the average gray scale value in case the display panel operates in a normally white mode and is in inverse proportion to the average gray scale value in case the display panel operates in a normally black mode.

12. The dimming device of claim 10, wherein the detector further comprises:
a first resistor having a first terminal and a second terminal, the first terminal electrically connected to a system power and the second terminal electrically connected to the display panel, wherein a current passing through the first resistor is in direct proportion to the real-time current, and the detector estimates the average gray scale value by a cross-voltage between the first terminal and the second terminal of the first resistor.

13. The dimming device of claim 12, wherein the detector further comprises:
a second resistor having a first terminal and a second terminal, the first terminal electrically connected to the first terminal of the first resistor;
a third resistor having a first terminal and a second terminal, the first terminal electrically connected to the second terminal of the second resistor and the second terminal electrically connected to a first voltage;
a voltage gain amplifier having an output terminal, a positive input terminal and a negative input terminal, the positive input terminal electrically connected to the first terminal of the third resistor;
a fourth resistor having a first terminal and a second terminal, the first terminal electrically connected to the second terminal of the first resistor and the second terminal electrically connected to the negative input terminal of the voltage gain amplifier; and
a fifth resistor having a first terminal and a second terminal, the first terminal electrically connected to the second terminal of the fourth resistor and the second terminal electrically connected to the output terminal of the voltage gain amplifier.

14. The dimming device of claim 10, wherein the dimming device further comprises:
a pulse-width modulation circuit electrically connected to the output terminal of the detector for receiving a PWN signal and adjusting a pulse width of the PWN signal;
a response time regulating circuit electrically connected to the pulse-width modulation circuit for adjusting a response time of the PWN signal; and
a phase setting circuit electrically connected to the response time regulating circuit for controlling a phase of the PWN signal.

15. The dimming device of claim 10, wherein the dimming circuit further comprises:
a first transistor having a first terminal, a second terminal and a gate electrode, the gate electrode electrically connected to an output terminal of the detector and the first terminal electrically connected to a first a voltage;
a second transistor having a first terminal, a second terminal and a gate electrode, the gate electrode used to receive the PWN signal and the first terminal electrically connected to the second terminal of the first transistor;
a third transistor having a first terminal, a second terminal and a gate electrode, the gate electrode used to receive the PWN signal and the first terminal electrically connected to the second terminal of the second transistor;
a fourth transistor having a first terminal, a second terminal and a gate electrode, the gate electrode electrically connected to the output terminal of the detector, the first terminal electrically connected to the second terminal of the third transistor, and the second terminal electrically connected to a second voltage;
a fifth transistor having a first terminal, a second terminal, and a gate electrode, the gate electrode electrically connected to the second terminal of the fourth transistor and the first terminal electrically connected to the first terminal of the first transistor;
a sixth transistor having a first terminal, a second terminal and a gate electrode, the gate electrode electrically connected to the second terminal of the second transistor and the first terminal electrically connected to the second terminal of the fifth transistor;
a seventh transistor having a first terminal, a second terminal and a gate electrode, the gate electrode electrically connected to the second terminal of the second transistor and the first terminal electrically connected to the second terminal of the sixth transistor;
an eighth transistor having a first terminal, a second terminal and a gate electrode, the gate electrode electrically connected to the first terminal of the first transistor, the first terminal electrically connected to the second terminal of the seventh transistor, and the second terminal electrically connected to the second terminal of the fourth transistor;
a ninth transistor having a first terminal, a second terminal and a gate electrode, the gate electrode electrically connected to the second terminal of the sixth transistor and the first terminal electrically connected to the first terminal of the first transistor;
a tenth transistor having a first terminal, a second terminal and a gate electrode, the gate electrode electrically connected to the second terminal of the sixth transistor, the first terminal electrically connected to the second terminal of the seventh transistor, and the second terminal electrically connected to the second terminal of the fourth transistor;
an eleventh transistor having a first terminal, a second terminal and a gate electrode, the gate electrode electrically connected to the second terminal of the ninth transistor and the first terminal electrically connected to the first terminal of the first transistor; and
a twelfth transistor having a first terminal, a second terminal and a gate electrode, the gate electrode electrically connected to the second terminal of the ninth transistor, the first terminal electrically connected to the second terminal of the eleventh transistor, and the second terminal electrically connected to the second terminal of the fourth transistor.

16. The dimming device of claim 10, wherein the backlight module is an edge-light type backlight module.

17. A dimming method for backlight module comprising:
detecting a real-time current of a frame displayed by a display panel for estimating an average gray scale value of the frame; and
adjusting a brightness of the backlight module according to the real-time current so that the brightness is in direct or inverse proportion to the average gray scale value.

18. The dimming method of claim 17, wherein the step of detecting a real-time current of a frame displayed by a display panel for estimating an average gray scale value of the frame further comprises:
detecting a cross-voltage between a first terminal and a second terminal of a resistor, wherein the first terminal of the resistor is electrically connected to a system power and the second terminal of the resistor is electrically connected to the display panel, a current passing through the resistor is in direct proportion to the real-time current; and
amplifying the cross-voltage to generate a voltage by a voltage gain amplifier.

19. The dimming method of claim 18, wherein step of adjusting a brightness of the backlight module according to a real-time current so that the brightness is in direct or inverse proportion to the average gray scale value further comprises:
adjusting a duty cycle of a dimming signal according to the voltage for adjusting the brightness.

20. The dimming method of claim 17, wherein the brightness is in direct proportion to the average gray scale value in case the display panel operates in a normally white mode, and the brightness is in inverse proportion to the average gray scale value in case the display panel operates in a normally black mode.
